(19) United States
(12) Patent Application Publication
(10) Pub. No.: US 2026/0031290 A1
(43) Pub. Date: Jan. 29, 2026

(54) MULTI-STAGE KEY STRUCTURE

(71) Applicant: Primax Electronics Ltd., Taipei (TW)

(72) Inventors: Che-An Li, Taipei (TW); Lei-Lung Tsai, Taipei (TW); Sheng-Fan Chang, Taipei (TW)

(21) Appl. No.: 18/810,227

(22) Filed: Aug. 20, 2024

(30) Foreign Application Priority Data
Jul. 29, 2024 (TW) 113128169

(51) Int. Cl. H01H 13/83; H01H 3/12

(52) U.S. Cl. CPC H01H 13/83; H01H 3/125; H01H 2219/06

(57) ABSTRACT

A multi-stage key structure includes a circuit board, a reflective optical component, a base plate and a keycap. The reflective optical component includes a light emitter and a light receiver that are disposed over the circuit board and separated from each other. The base plate is disposed over the circuit board and has at least one first through hole accommodating the reflective optical component. The keycap has a light-blocking reflective member facing the light emitter and the light receiver of the reflective optical component, in which the light emitter is configured to emit a light beam toward the light-blocking reflective member, and the light-blocking reflective member is configured to reflect the light beam to the light receiver.

### FIELD OF THE INVENTION

The present invention relates to a multi-stage key structure, and in particular to a multi-stage key structure including a reflective optical component.

### BACKGROUND OF THE INVENTION

Most of common key structures on the market can only switch between on and off. However, needs of users are increasing day by day, and the aforementioned key structures no longer meet needs of some users. For example, game users require keys with multi-stage triggering functions and good sensitivity to ensure instantaneous and precise key operations during gaming experience. Therefore, a novel key structure is needed in this field in order to meet the needs of such users.

### SUMMARY OF THE INVENTION

The present invention provides a multi-stage key structure, which includes a circuit board, a reflective optical component, a base plate and a keycap. The reflective optical component includes a light emitter and a light receiver that are disposed over the circuit board and separated from each other. The base plate is disposed over the circuit board and has at least one first through hole accommodating the reflective optical component. The keycap has a light-blocking reflective member facing the light emitter and the light receiver of the reflective optical component, in which the light emitter is configured to emit a light beam toward the light-blocking reflective member, and the light-blocking reflective member is configured to reflect the light beam to the light receiver.

In some embodiments of the present invention, the light-blocking reflective member is black.

In some embodiments of the present invention, a lower surface of the light-blocking reflective member is substantially coplanar with an inner top surface of the keycap.

In some embodiments of the present invention, a bottom-view area of the light-blocking reflective member is greater than a top-view area of the reflective optical component.

In some embodiments of the present invention, the multi-stage key structure further includes a scissor-type connecting element, which is connected between the keycap and the base plate and includes: an inner frame, having a first through opening; and an outer frame, configured to swing relative to the inner frame, and having a second through opening corresponding to the first through opening, in which a vertical projection of the reflective optical component is located within a vertical projection of the first through opening and a vertical projection of the second through opening.

In some embodiments of the present invention, the multi-stage key structure further includes a returning member, disposed between the keycap and the base plate and located in the first through opening and the second through opening.

In some embodiments of the present invention, a width of a top of the returning member is greater than a width of a bottom of the returning member.

In some embodiments of the present invention, the multi-stage key structure further includes a light-emitting element, disposed over the circuit board and separated from the reflective optical component, in which the base plate further has a second through hole separated from the at least one first through hole and accommodating the light-emitting element.

In some embodiments of the present invention, a vertical projection of the light-emitting element is located within the vertical projection of the first through opening and the vertical projection of the second through opening.

In some embodiments of the present invention, the reflective optical component and the light-emitting element are respectively disposed at opposite sides of the returning member.

### BRIEF DESCRIPTION OF THE DRAWINGS

Aspects of the present invention are best understood from the following embodiments, read in conjunction with accompanying drawings. However, it should be understood that in accordance with common practice in the industry, various features have not necessarily been drawn to scale. Indeed, shapes of the various features may be suitably adjusted for clarity, and dimensions of the various features may be arbitrarily increased or decreased.

FIG. 1 is an appearance diagram of a multi-stage key structure according to an embodiment of the present invention.

FIG. 2 is a cross-sectional view of a multi-stage key structure according to an embodiment of the present invention.

FIG. 3 is a bottom perspective view of a keycap and a light-blocking reflective member according to an embodiment of the present invention.

FIG. 4 is an exploded view of FIG. 3.

FIG. 5 is a top perspective view of a multi-stage key structure (a keycap and a light-blocking reflective member are not shown) according to an embodiment of the present invention.

FIG. 6 is a top view of FIG. 5.

### DETAILED DESCRIPTION OF THE PREFERRED EMBODIMENT

The advantages and features of the present invention and the method for achieving the same will be described in more detail with reference to exemplary embodiments and accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180°, the relationship between the one element and the other element may change from “beneath” to “over.” The spatially relative descriptions used herein should be interpreted the same.

As mentioned in the prior art, needs of users are increasing day by day. For example, game users require keys with multi-stage triggering functions and good sensitivity to ensure instantaneous and precise key operations during gaming experience. Therefore, the present invention provides a multi-stage key structure, which includes a circuit board, a reflective optical component including a light emitter and a light receiver, a base plate, and a keycap having a light-blocking reflective member. The light emitter is configured to emit a light beam toward the light-blocking reflective member, and the light-blocking reflective member is configured to reflect the light beam to the light receiver. When the keycap is pressed, a distance between the reflective optical component and the light-blocking reflective member changes, and a light reception amount (light intensity) of the light receiver changes, causing a signal (e.g., a voltage value) output by the light receiver to a controller to change, and the controller then outputs an analog signal to an electronic device (e.g., a laptop), so that the electronic device performs a corresponding function. Therefore, the key structure of the present invention has multi-stage triggering functions and good sensitivity, allowing the user to accurately control a trigger point and pressure of the key, thereby meeting the user's needs for immediacy and accuracy in key operations. In addition, the key structure of the present invention can also provide diversified and personalized usage experience to meet needs of different users. Various embodiments of the multi-stage key structure of the present invention will be described in detail below.

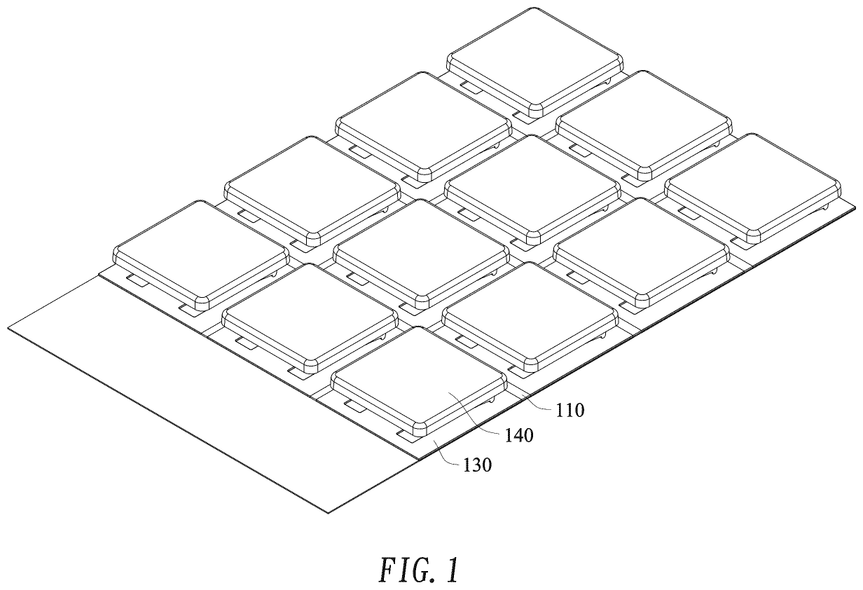

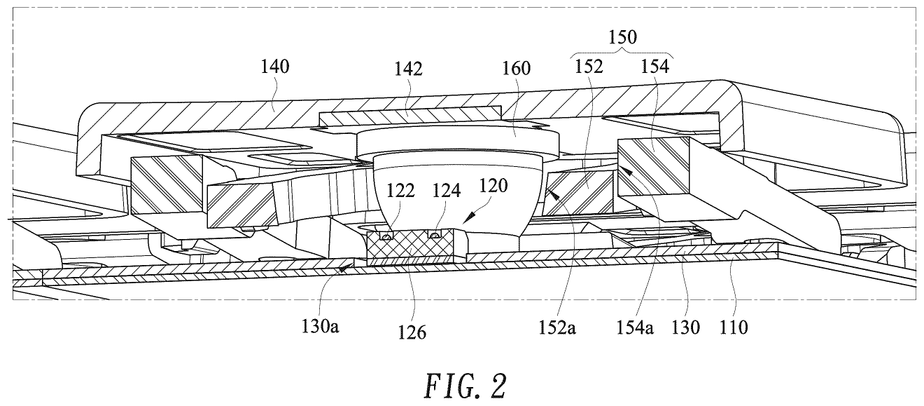

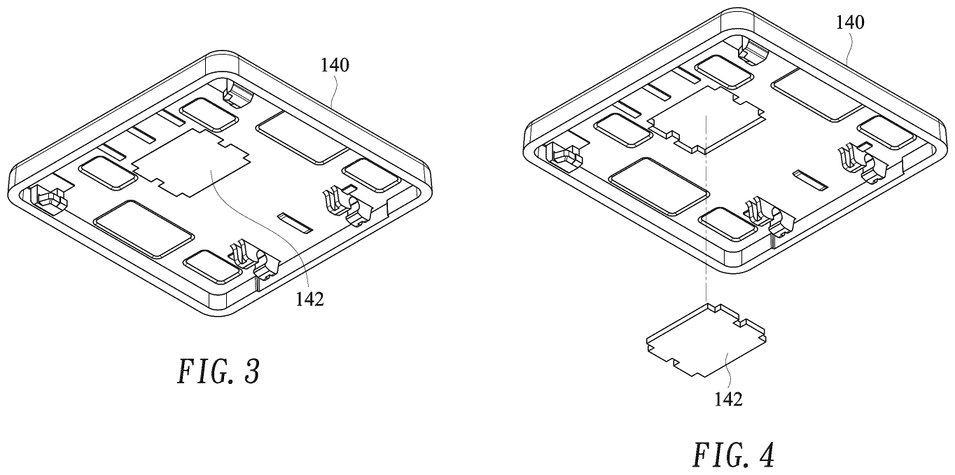

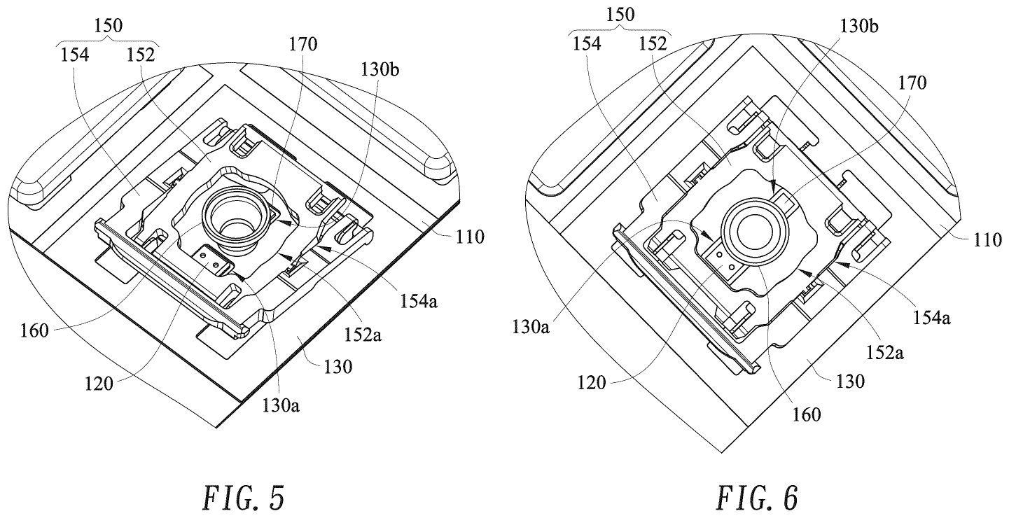

FIG. 1 is an appearance diagram of a multi-stage key structure according to an embodiment of the present invention. FIG. 2 is a cross-sectional view of a multi-stage key structure according to an embodiment of the present invention. FIG. 3 is a bottom perspective view of a keycap and a light-blocking reflective member according to an embodiment of the present invention. FIG. 4 is an exploded view of FIG. 3. FIG. 5 is a top perspective view of a multi-stage key structure (a keycap and a light-blocking reflective member are not shown) according to an embodiment of the present invention. FIG. 6 is a top view of FIG. 5. As shown in FIGS. 1 to 6, the multi-stage key structure includes a circuit board 110, a reflective optical component 120, a base plate 130 and a keycap 140.

In some embodiments, as shown in FIGS. 1, 2, 5 and 6, the circuit board 110 is, for example, a flexible printed circuit board (FPC). However, the present invention is not limited thereto. In other embodiments, the circuit board 110 may be other types of circuit boards.

As shown in FIGS. 2 and 5, the reflective optical component 120 includes a light emitter 122 and a light receiver 124 that are disposed over the circuit board 110 and separated from each other. In some embodiments, the light emitter 122 is an infrared light emitter, and the light receiver 124 is an infrared light receiver. In some embodiments, the light emitter 122 is an infrared light-emitting diode, and the light receiver 124 is a photo transistor (PT). In some embodiments, the reflective optical component 120 further includes a packaging structure 126 that isolates the light emitter 122 and the light receiver 124.

As shown in FIGS. 1, 2, 5 and 6, the base plate 130 is disposed on the circuit board 110 and has at least one first through hole 130a accommodating the reflective optical component 120. In some embodiments, the base plate 130 is supportive, and may be, for example, an iron plate or a plate made of another suitable material.

As shown in FIGS. 2 to 4, the keycap 140 has a light-blocking reflective member 142 facing the light emitter 122 and the light receiver 124 of the reflective optical component 120. The light-blocking reflective member 142 has a function of blocking sunlight to prevent it from affecting operations of the reflective optical component 120. The light emitter 122 is configured to emit a light beam toward the light-blocking reflective member 142, and the light-blocking reflective member 142 is configured to reflect the light beam to the light receiver 124.

When the keycap 140 is pressed, a distance between the reflective optical component 120 and the light-blocking reflective member 142 becomes smaller, and a light reception amount (light intensity) of the light receiver 124 becomes larger, so that a signal (e.g., a voltage value) output by the light receiver 124 to a controller becomes larger, and the controller then outputs an analog signal to an electronic device (e.g., a laptop), so that the electronic device performs a corresponding function.

In some embodiments, the light-blocking reflective member 142 is black, which can effectively prevent sunlight from affecting the operations of the reflective optical component 120. In some embodiments, referring to FIGS. 3 and 4, the keycap 140 and the light-blocking reflective member 142 are manufactured using a dual-material injection process. In some embodiments, a lower surface of the light-blocking reflective member 142 is substantially coplanar with an inner top surface of the keycap 140 to save material usage and reduce space occupation. In some embodiments, as shown in FIG. 2, a bottom-view area of the light-blocking reflective member 142 is larger than a top-view area of the reflective optical component 120. In practical applications, the location, shape, and area of the light-blocking reflective member 142 are determined according to a field of view (FOV) of the light emitter 122 and the light receiver 124, so that the light receiver 124 can effectively receive the reflected light beam. In some embodiments, a visual range of the light emitter 122 and the light receiver 124 is less than or equal to 35 degrees, such as 30 degrees.

In some embodiments, as shown in FIGS. 2, 5 and 6, the multi-stage key structure further includes a scissor-type connecting element 150, which is connected between the keycap 140 and the base plate 130, and includes an inner frame 152 and an outer frame 154. The inner frame 152 has a first through opening 152a. The outer frame 154 is configured to swing relative to the inner frame 152 and has a second through opening 154a corresponding to the first through opening 152a. A vertical projection of the reflective optical component 120 is located within a vertical projection of the first through opening 152a of the inner frame 152 and a vertical projection of the second through opening 154a of the outer frame 154. Compared with arranging a reflective optical component (not shown) in a space outside the inner frame 152 and the outer frame 154, the reflective optical component 120 of the present invention does not need to occupy additional space, and therefore there is no need to change the position of the scissor-type connecting element 150.

In some embodiments, as shown in FIGS. 2, 5 and 6, the multi-stage key structure further includes a returning member 160, which is disposed between the keycap 140 and the base plate 130, and is located in the first through opening 152a and the second through opening 154a. The returning member 160 is configured to enable the keycap 140 to return to its original position after being pressed. In some embodiments, the return member 160 is a rubber dome, a spring, or another element with elastic functions. In some embodiments, a width of a top of the returning member 160 is greater than a width of a bottom of the returning member 160. In some embodiments, the returning member 160 and the keycap 140 may be manufactured using a dual-material injection process.

However, the present invention is not limited to the above embodiments. In other embodiments, the returning member 160 may be disposed upside down, that is, a width of a bottom of the returning member 160 is greater than a width of a top of the returning member 160. In other embodiments, the inverted returning member 160 is fixed on the base plate 130 or another carrier (e.g., an insulating film (such as Mylar), not shown).

In some embodiments, as shown in FIGS. 5 and 6, the multi-stage key structure further includes a light emitting element 170, which is disposed over the circuit board 110 and separated from the reflective optical component 120 to provide a backlight effect. In some embodiments, the base plate 130 further has a second through hole 130b, which is separated from the at least one first through hole 130a and accommodates the light emitting element 170. In some embodiments of the present invention, a vertical projection of the light emitting element 170 is located within the vertical projection of the first through opening 152a of the inner frame 152 and the vertical projection of the second through opening 154a of the outer frame 154. In some embodiments, the reflective optical component 120 and the light-emitting element 170 are respectively disposed at opposite sides of the returning member 160. In some embodiments, the width of the top of the returning member 160 is greater than the width of the bottom of the returning member 160, so there is enough space near the bottom of the returning member 160 to dispose the reflective optical element 120 and the light-emitting element 170.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not intended to limit the scope of claims of the present invention.

What is claimed is:

1. A multi-stage key structure, comprising:
a circuit board;
a reflective optical component, comprising a light emitter and a light receiver that are disposed over the circuit board and separated from each other;
a base plate, disposed over the circuit board and having at least one first through hole accommodating the reflective optical component; and
a keycap, having a light-blocking reflective member facing the light emitter and the light receiver of the reflective optical component, in which the light emitter is configured to emit a light beam toward the light-blocking reflective member, and the light-blocking reflective member is configured to reflect the light beam to the light receiver.

2. The multi-stage key structure of claim 1, wherein the light-blocking reflective member is black.

3. The multi-stage key structure of claim 1, wherein a lower surface of the light-blocking reflective member is substantially coplanar with an inner top surface of the keycap.

4. The multi-stage key structure of claim 1, wherein a bottom-view area of the light-blocking reflective member is greater than a top-view area of the reflective optical component.

5. The multi-stage key structure of claim 1, further comprising:
a scissor-type connecting element, connected between the keycap and the base plate, and comprising:
an inner frame, having a first through opening; and
an outer frame, configured to swing relative to the inner frame, and having a second through opening corresponding to the first through opening, wherein a vertical projection of the reflective optical component is located within a vertical projection of the first through opening and a vertical projection of the second through opening.

6. The multi-stage key structure of claim 5, further comprising:
a returning member, disposed between the keycap and the base plate and located in the first through opening and the second through opening.

7. The multi-stage key structure of claim 6, wherein a width of a top of the returning member is greater than a width of a bottom of the returning member.

8. The multi-stage key structure of claim 6, further comprising:
a light-emitting element, disposed over the circuit board and separated from the reflective optical component, wherein the base plate further has a second through hole separated from the at least one first through hole and accommodating the light-emitting element.

9. The multi-stage key structure of claim 8, wherein a vertical projection of the light-emitting element is located within the vertical projection of the first through opening and the vertical projection of the second through opening.

10. The multi-stage key structure of claim 8, wherein the reflective optical component and the light-emitting element are respectively disposed at opposite sides of the returning member.
